(19) United States
(12) Patent Application Publication
(10) Pub. No.: US 2017/0177716 A1
(43) Pub. Date: Jun. 22, 2017

(54) TECHNOLOGIES FOR SEMANTIC INTERPRETATION OF USER INPUT BY A DIALOGUE MANAGER

(71) Applicant: Intel Corporation, Santa Clara, CA (US)

(72) Inventors: Guillermo Perez, Sevilla (ES); Manuel Castro, Tomares (ES); Israel Perez De Tudela, Alcala del Rio (ES)

(21) Appl. No.: 14/979,113

(22) Filed: Dec. 22, 2015

(51) Int. Cl. G06F 17/30; G10L 15/22; G06F 17/27

(52) U.S. Cl. CPC G06F 17/30705; G06F 17/30684; G06F 17/3053; G06F 17/279; G06F 17/271; G10L 15/22

(57) ABSTRACT

Technologies for interpreting an input from a user of a compute device are disclosed. The compute device may capture input data from, for example, a microphone. The compute device is configured to recognize the speech in the input data, and determines one or more semantic interpretations of the input data. The compute device ranks the semantic interpretations, and selects and applies one of the semantic interpretations. In ranking the semantic interpretations, the compute device may consider factors such as the dialogue history and the dialogue coherence of the semantic interpretations, as well as the confidence of how well each semantic interpretation matches the input data.

### BACKGROUND

Despite the computational ability of modern compute devices, certain tasks such as pattern recognitions and speech detection and interpretation remain challenging. There has been significant progress with word recognition using, Hidden Markov Models, deep learning, and similar techniques. However, even with those advances, interpretation of user input is well short of what would be expected if speaking with a person.

A spoken dialogue system is one area which employs speech recognition. In a dialogue system, a dialogue manager of the compute device provides outputs to a user, and receives input from the user. The dialogue system then performs speech recognition and selects a dialogue move based on the recognized speech.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a compute device for interpreting an input from a user of the compute device;

FIG. 2 is a block diagram of at least one embodiment of an environment that may be established by the compute device of FIG. 1; and

FIGS. 3-4 are a simplified flow diagram of at least one embodiment of a method for interpreting an input from a user that may be executed by the compute device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

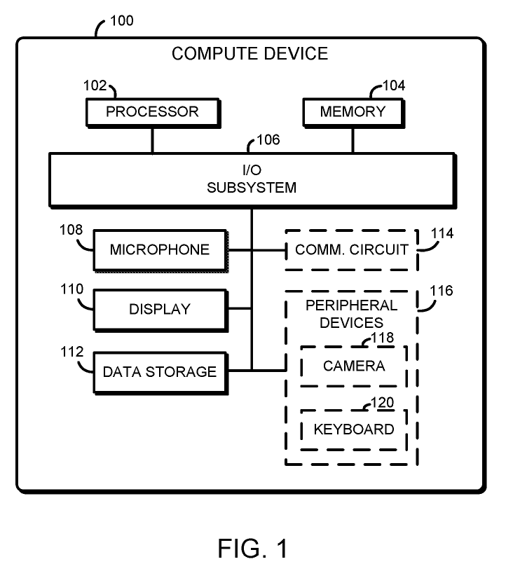

Referring now to FIG. 1, an illustrative compute device 100 includes a processor 102, a memory 104, an input/output (I/O) subsystem 106, a microphone 108, a display 110, and data storage 112. The compute device 100 may be embodied as any type of compute device capable of performing the functions described herein. For example, the compute device 100 may be embodied as or otherwise be included in, without limitation, a smartphone, a cellular phone, an embedded computing system, a System-on-a-Chip (SoC), a desktop computer, a server computer, a tablet computer, a notebook computer, a laptop computer, a wearable computer, a handset, a messaging device, a camera device, a multiprocessor system, a processor-based system, a consumer electronic device, and/or any other computing device. In some embodiments, one or more of the illustrative components of the compute device 100 may be incorporated in, or otherwise form a portion of, another component. For example, the memory 104, or portions thereof, may be incorporated in the processor 102 in some embodiments.

In the illustrative embodiment, in use and as described in more detail below, the compute device 100 uses a dialogue manger to manage or otherwise control a dialogue between the compute device 100 and a user of the compute device 100. When the illustrative dialogue manager determines that an input is required from the user, the dialogue manager provides a prompt to the user, such as by displaying a question on the display 110. The compute device 100 receives input data by capturing sound data using the microphone 108. In other embodiments, the user may initiate the dialogue, and the compute device 100 may receive input data without providing a prompt to the user. The compute device 100 then performs automatic speech recognition on the input data, and determines several recognized input candidates of the speech data (i.e., different possible transcriptions of the input data). The compute device 100 determines, for each recognized input candidate, one or more semantic interpretation candidates. As described in more detail below, the compute device 100 ranks each semantic interpretation candidate based on the prompt, such as by determining how coherent each semantic interpretation candidate is in light of the prompt. The compute device 100 is configured to select a semantic interpretation based on the rankings and apply a corresponding dialogue move. A dialogue move may be defined as a move that changes the state of the dialogue, e.g., by selecting a command or next action for the dialogue manager to take.

In the illustrative embodiment, a semantic interpretation may be defined as an interpretation of the intended meaning of the input data. In some embodiments, a semantic interpretation matches one of a pre-determined set of actions that the dialogue manager can take in response to the input from the user. In other embodiments, a semantic interpretation may be more open-ended, and the compute device 100 may analyze the semantic interpretation to determine an action to take in response. For example, in one embodiment, the prompt may ask the user to whom he or she wants to place a phone call. A transcription of the input data captured in response to the prompt may match the name of a person in the user's contact list, the name of a person not in the user's contact list, a list of digits corresponding to a phone number, or a command such as “cancel call.” In this example, the semantic interpretation for the transcription matching a phone number or matching the name of a person in the user's contact list may be to call that person, the semantic interpretation for the transcription matching the name of a person not in the user's contact list may be to ask the user for more information, and the semantic interpretation for the transcription matching a command such as “cancel call” may be to end the current dialogue without placing a call.

The processor 102 may be embodied as any type of processor capable of performing the functions described herein. For example, the processor 102 may be embodied as a single or multi-core processor(s), a single or multi-socket processor, a digital signal processor, a graphics processor, a microcontroller, or other processor or processing/controlling circuit. Similarly, the memory 104 may be embodied as any type of volatile or non-volatile memory or data storage capable of performing the functions described herein. In operation, the memory 104 may store various data and software used during operation of the compute device 100 such as operating systems, applications, programs, libraries, and drivers. The memory 104 is communicatively coupled to the processor 102 via the I/O subsystem 106, which may be embodied as circuitry and/or components to facilitate input/output operations with the processor 102, the memory 104, and other components of the compute device 100. For example, the I/O subsystem 106 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 106 may form a portion of a system-on-a-chip (SoC) and be incorporated, along with the processor 102, the memory 104, and other components of the compute device 100 on a single integrated circuit chip.

The microphone 108 may be embodied as any type of device capable of converting sound into an electrical signal, and includes microphones based on electromagnetic induction, capacitance change, and/or piezoelectricity. The display 110 may be embodied as any type of display on which information may be displayed to a user of the compute device 100, such as a liquid crystal display (LCD), a light emitting diode (LED) display, a cathode ray tube (CRT) display, a plasma display, an image projector (e.g., 2D or 3D), a laser projector, a touchscreen display, a heads-up display, and/or other display technology.

The data storage 112 may be embodied as any type of device or devices configured for the short-term or long-term storage of data. For example, the data storage 112 may include any one or more memory devices and circuits, memory cards, hard disk drives, solid-state drives, or other data storage devices.

Of course, in some embodiments, the compute device 100 may include other or additional components, such as those commonly found in a compute device. For example, the compute device 100 may also have a communication circuit 114 and/or peripheral devices 116 such as a camera 118, a keyboard 120, a mouse, a speaker, etc.

The communication circuit 114 may be embodied as any type of communication circuit, device, or collection thereof, capable of enabling communications between the compute device 100 and other devices. To do so, the communication circuit 114 may be configured to use any one or more communication technology and associated protocols (e.g., Ethernet, Bluetooth®, Wi-Fi®, WiMAX, near field communication (NFC), etc.) to effect such communication.

The camera 118 may be embodied as any type of device capable of sensing or capturing an image. For example, the camera 118 may be embodied as, or otherwise include a charge-coupled device (CCD) camera, a complementary metal-oxide-semiconductor (CMOS) camera, and/or other type of image sensor technology. Additionally, the camera 118 may be embodied as a two-dimensional or a three-dimensional camera (i.e., configured to capture/generate 2D or 3D images). The camera 118 may be configured to sense single or multiple images (e.g., video), and sense visible light and/or invisible light, including infrared light, thermal light, ultra-violet light, x-rays, and/or the like.

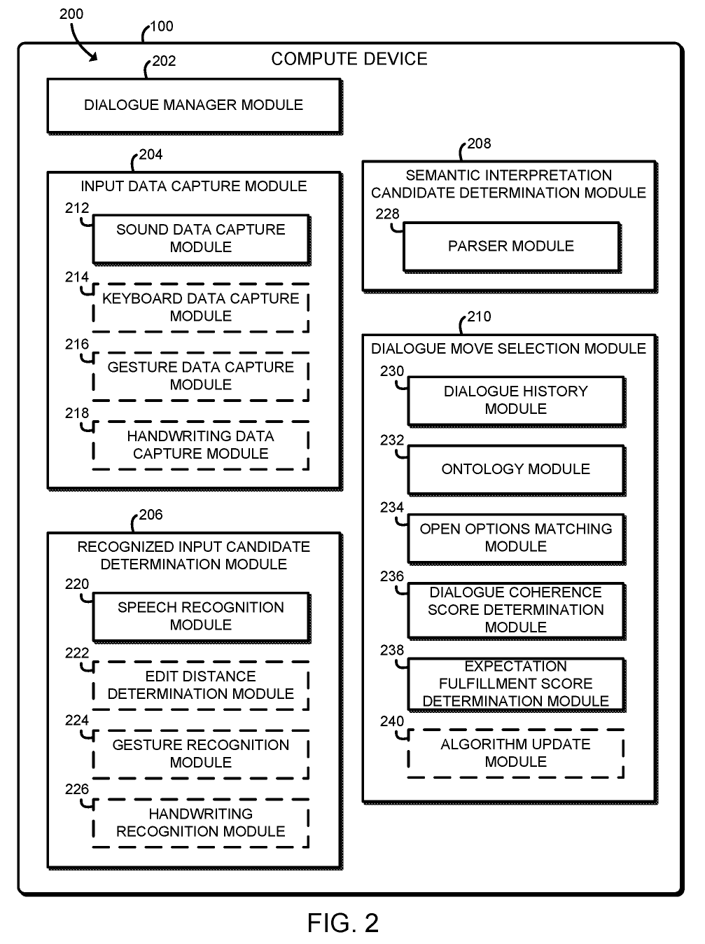

Referring now to FIG. 2, in use, the compute device 100 may establish an environment 200. The illustrative environment 200 includes a dialogue manager module 202, an input data capture module 204, a recognized input candidate determination module 206, a semantic interpretation candidate determination module 208, and a dialogue move selection module 210. The various modules of the environment 200 may be embodied as hardware, software, firmware, or a combination thereof. For example, the various modules, logic, and other components of the environment 200 may form a portion of, or otherwise be established by, the processor 102 or other hardware components of the compute device 100. As such, in some embodiments, one or more of the modules of the environment 200 may be embodied as circuitry or collection of electrical devices (e.g., a dialogue manager circuit 202, an input data capture circuit 204, a recognized input candidate determination circuit 206, etc.). It should be appreciated that, in such embodiments, one or more of the circuits (e.g., the dialogue manager circuit 202, the input data capture circuit 204, the recognized input candidate determination circuit 206, etc.) may form a portion of one or more of the processor 102, the memory 104, the I/O subsystem 106, and/or the data storage 112. Additionally, in some embodiments, one or more of the illustrative modules may form a portion of another module and/or one or more of the illustrative modules may be independent of one another.

The dialogue manager module 202 is configured to control at least a portion of the state and/or flow of an application or process that can be run on the compute device 100, and in particularly is configured to control at least the state and/or flow of the dialogue between the user and the compute device 100. When the application or process requires an input from the user, the dialogue manager module 202 presents a prompt to the user, and after the semantic interpretation of the user input is determined (described in more detail below), the dialogue manager module 202 applies the semantic interpretation of the user input by making a dialogue move.

The input data capture module 204 is configured to capture input from the user. In the illustrative embodiment, the input data capture module 204 uses the sound data capture module 212 to capture input data from the microphone 108. In additional embodiments, the input data capture module 204 may include a keyboard data capture module 214 to capture input from the keyboard 120, a gesture data capture module 216 to capture gesture data from the camera 118, and/or a handwriting data capture module 218 to capture handwriting data from, e.g., the display 110. As stated above, the display 110 may be a touchscreen display, and handwriting data may be captured by capturing a user moving his or her finger on the display 110.

The recognized input candidate determination module 206 is configured to determine one or more recognized input candidates based on the input data captured by the input data capture module 204. The recognized input candidates are different possible inputs that the user may have intended. The recognized input candidate determination module 206 is also configured to determine a confidence score for each recognized input candidate indicating a likelihood or confidence of the compute device 100 that the corresponding recognized input candidate is the correct input as intended by the user. For example, in the illustrative embodiment, the speech recognition module 220 performs automatic speech recognition on the speech data captured by the input data capture module 204. The speech recognition module determines one or more recognized input candidates corresponding to possible transcriptions of the speech data. In some cases, the one or more recognized input candidates may be embodied as a word lattice, which would allow for the representation of a large number of recognized input candidates in a compact form. Any technique or algorithm for speech recognition may be used, such as hidden Markov models, deep neural networks, or the like. The most likely transcription may be generated in the standard manner, but one or more additional transcriptions may also be generated and be used as recognized input candidates as well, even if the speech recognition algorithm indicates that those transcriptions are not the most likely to be correct.

In embodiments in which the input data is captured by the keyboard 120, the edit distance determination module 222 determines one or more recognized input candidates corresponding to possible intended text entries, based on the edit distance from the entered text. The edit distance is indicative of how close the entered text is to the candidate intended text, e.g., the minimum number of single-character edits to change the entered text to the intended text. In embodiments in which the input data is gesture data captured by the camera 118, the gesture recognition module 224 performs gesture recognition on the gesture data and determines one or more recognized input candidates corresponding to candidate gestures that the gesture data may match. In embodiments in which in the input data is handwriting data captured by the display 110, the handwriting recognition module 226 recognizes one or more recognized input candidates corresponding to text interpretations of the handwriting data. In each of these additional embodiments, any technique for automatic recognition of the input data may be used, including hidden Markov models, deep neural networks, or the like.

The semantic interpretation candidate determination module 208 is configured to determine one or more semantic interpretation candidates for each recognized input candidate. The semantic interpretation candidate determination module 208 may consider possible errors made by the user in providing the input, such as a mispronunciation, a typographical error, or a misspelling, and generate semantic interpretation candidates that correct the possible errors. The semantic interpretation candidate determination module 208 includes a parser module 228. The parser module 228 is configured to parse a string of words, which may be useful in embodiments wherein the recognized input candidates may be strings of words, such as the output of speech recognition in the illustrative embodiment. While some recognized input candidates may be trivial to parse, such as when the recognized input candidate is a single word or a person's name, others may contain syntactic ambiguities, or other ambiguities such as lexical ambiguities or pragmatic ambiguities. The parser module 228 is configured to not resolve the ambiguities, but instead to determine a semantic interpretation for each possible syntactic interpretation of each recognized input candidate. In some embodiments, the semantic interpretation candidate determination module 208 may determine the semantic interpretation candidates directly from the input data, without explicitly determining recognized input candidates. For example, the semantic interpretation candidate determination module 208 may determine the semantic interpretation candidates using a machine-learning-trained algorithm. In additional embodiments, the semantic interpretation candidate determination module 208 may employ both parsing and a machine-learning-trained algorithm in order to determine additional semantic interpretation candidates.

The dialogue move selection module 210 is configured to rank the semantic interpretation candidates based on at least the prompt provided to the user, and to select one of the semantic interpretations to be applied. As part of the ranking process, the dialogue move selection module 210 may consider the confidence score for the recognized input candidate corresponding to each semantic interpretation candidate, and may also access a dialogue history module 230, an ontology module 232, an open options matching module 234, a dialogue coherence score determination module 236, and an expectation fulfillment score determination module 238. The dialogue history module 230 is configured to provide the history of the dialogue between the user and the compute device 100. The ontology module 232 is configured to represent information accessible to the dialogue move selection module 210, such as a list of contacts saved by the user. The open options matching module 234 is configured to determine how well each of the semantic interpretation candidates matches each open option in circumstances in which there may be a limited number of acceptable responses, such as when the prompt asks the user to choose between a set of options. The dialogue coherence score determination module 236 is configured to determine a dialogue coherence score indicative of how coherent each semantic interpretation candidate is with the dialogue. For example, the dialogue coherence score determination module 236 may determine if each semantic interpretation candidate is related to the same topic as the previous interactions between the compute device 100 and the user. The expectation fulfillment score determination module 238 is configured to determine an expectation fulfillment score indicative of how well each semantic interpretation candidate fulfills an expectation from previous interactions. For example, if the prompt asks the user what his or her favorite color is, the expectation fulfillment score determination module 238 will determine how well each semantic interpretation candidate fulfills the expectation to answer the prompt with a color.

In the illustrative embodiment, the dialogue move selection module 210 may in some cases use an algorithm that has been trained using machine learning, such as a neural network, a support vector machine, or the like in order to make determinations such as the dialogue coherence score. In that embodiment, the dialogue move selection module 210 may include an algorithm update module 240. The algorithm update module 240 is configured to continue the machine learning process as more interactions between the compute device 100 and the user occur, and to update the algorithm accordingly.

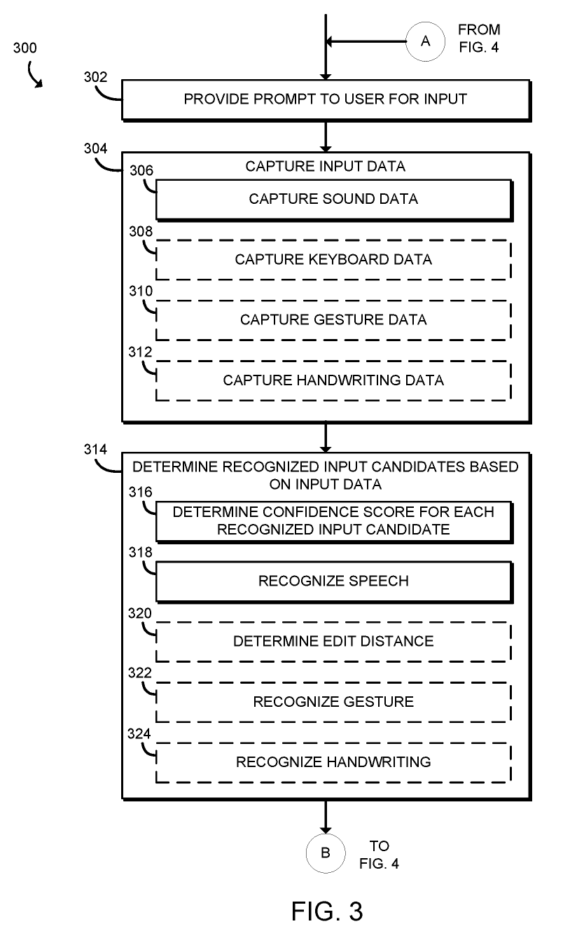

Referring now to FIG. 3, in use, the compute device 100 may execute a method 300 for interpreting an input from a user of the compute device 100. The method 300 begins with block 302, in which the compute device 100 provides a prompt to the user for input. The prompt may be displayed on the display 110, may be played through a speaker, or may otherwise be provided to the user. In some embodiments, the user may provide input to the compute device 100 without a prompt being provided by, for example, asking a question of the compute device 100 or giving an instruction to the compute device 100.

In block 304, the compute device 100 captures input data from the user. In the illustrative embodiment, the compute device 100 captures sound data in block 306 using the microphone 108. In other embodiments, the compute device 100 may capture keyboard data from a keyboard 120 in block 308, gesture data from a camera 118 in block 310, and/or handwriting data from the display 110 in block 312.

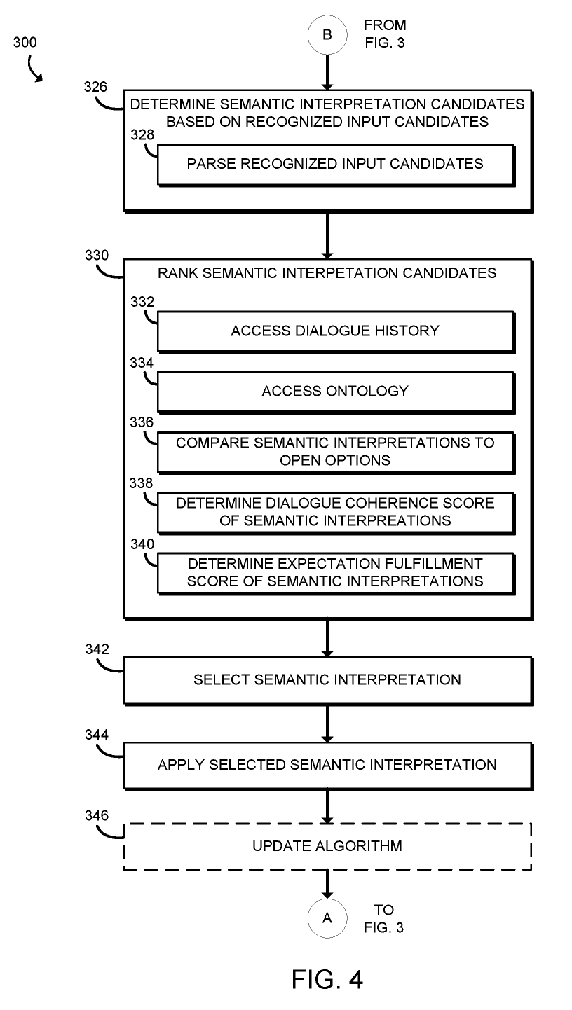

In block 314, the compute device 100 determines one or more recognized input candidates based on the input data. Additionally, in block 316, the compute device 100 determines a confidence score for each recognized input candidate. As discussed above, the confidence score indicates a likelihood or confidence of the compute device 100 that the corresponding recognized input candidate is the correct input as intended by the user. In the illustrative embodiment and as described in more detail above, the compute device 100 determines the recognized input candidates by recognizing speech based on the input data captured from the microphone 108 in block 318. The compute device 100 may determine one or more possible transcriptions of the speech data, and determine a recognized input candidate for each transcription. In additional embodiments, also described in more detail above, the compute device 100 may determine an edit distance for one or more candidate intended texts based on keyboard data in block 320, one or more possible candidate gestures based on gesture data in block 322 by recognizing a gesture, and/or one or more possible candidate text interpretations based on handwriting data in block 324 by recognizing handwriting. After the compute device 100 has determined the one or more recognized input candidates, the method proceeds to block 326 in FIG. 4.

In block 326, the compute device 100 determines a semantic interpretation candidate for each recognized input candidates. In block 328, in embodiments in which the recognized input candidates are embodied as strings of words, the compute device 100 parses each recognized input candidate into one or more semantic interpretations. In some embodiments, the compute device 100 may determine the one or more semantic interpretation candidates based directly on the input data, and may not explicitly determine different recognized input candidates as described above.

In block 330, the compute device 100 ranks each semantic interpretation candidate based on at least the prompt provided to the user. As part of the ranking process, the compute device 100 may consider the confidence score of each recognized input candidate corresponding to each semantic interpretation candidate, and may access the dialogue history in block 332 and may access the ontology in block 334. In block 336, the compute device may compare each semantic interpretation candidate to open options in order to determine if each semantic interpretation candidate matches an open option. In block 338, the compute device may determine a dialogue coherence score of each semantic interpretation candidate in block 338 by, for example, determining if the semantic interpretation candidate is related to a current topic of the dialogue. In block 340, the compute device may determine a fulfillment expectation score of each semantic interpretation candidate by determining how well each semantic interpretation candidate fulfills an expectation from previous interactions.

In an example, the user may state to the compute device 100, “Call Bob.” The compute device 100 may determine that the user intends to call a person named Bob, but that the user may intend either Bob Jones or Bob Smith, both of which may be in the user's contact list. The compute device 100 may provide the prompt, “Do you want to call Bob Jones or Bob Smith?” The compute device 100 may then capture an input from the user with the microphone 108, and perform automatic speech recognition on the captured input data. The recognized input candidates may be “Rob Jones,” “Bob Jones,” or “Rob Holmes,” with the corresponding semantic interpretation being to place a call to the corresponding name. In ranking the semantic interpretations, the compute device 100 may review the dialogue history and compare the semantic interpretation to the open options of Bob Jones and Bob Smith, and rank “Bob Jones” as the most likely semantic interpretation, even if “Rob Jones” and/or “Rob Holmes” had a higher confidence score for the corresponding recognized input candidate.

In another example, the compute device 100 may be dialoguing with the user using the keyboard 120. The compute device 100 may ask the user, “What kind of fruit would you like to eat?” The user may type on the keyboard 120 “peam.” The recognized input candidates may be “pear,” “beam,” or “team,” each of which could be a result of a single-character typographical error. The compute device 100 may access the ontology, and determine that, of the recognized input candidates, only “pear” is a fruit. Considering the prompt, it is clear that “pear” is coherent with the dialogue history and fulfills the expectation of providing a fruit in response to the prompt, and so “pear” would be ranked as the most likely semantic interpretation candidate.

Referring again to FIG. 4, in block 342, the compute device 100 selects a semantic interpretation based on the ranking of semantic interpretation candidates. In block 344, the compute device 100 applies the selected semantic interpretation. For example, the compute device 100 may perform an action based on the selected semantic interpretation and/or otherwise proceed with processing using the semantic interpretation as the user input.

Optionally, in block 346, the compute device 100 applies a machine learning algorithm to update the algorithm for interpreting an input from a user. The additional information from the dialogue interaction may make future interactions more accurate in selecting the correct semantic interpretation of future input. The method 300 may then return to block 302 in FIG. 3 in which the compute device 100 may provide a subsequent prompt to the user.

### EXAMPLES

Illustrative examples of the devices, systems, and methods disclosed herein are provided below. An embodiment of the devices, systems, and methods may include any one or more, and any combination of, the examples described below.

Example 1 includes a compute device for interpreting an input from a user of the compute device comprising an input data capture module to receive input data from the user; a semantic interpretation candidate determination module to determine a plurality of semantic interpretation candidates based on the input data; and a dialogue move selection module to (i) rank each semantic interpretation candidate of the plurality of semantic interpretation candidates and (ii) select, based on the ranking, a semantic interpretation of the input data.

Example 2 includes the subject matter of Example 1, and further including a dialogue manager module to provide, to the user, a prompt for input, wherein to receive input data comprises to receive input data in response to the prompt, and wherein to rank each semantic interpretation candidate of the plurality of semantic interpretation candidates comprises to rank, based on the prompt, each semantic interpretation candidate of the plurality of semantic interpretation candidates.

Example 3 includes the subject matter of any of Examples 1 and 2, and wherein the dialogue move selection module is further to determine a plurality of open options associated with the prompt, wherein to rank each semantic interpretation candidate of the plurality of semantic interpretation candidates further comprises to compare each semantic interpretation candidate of the plurality of semantic interpretation candidates to an open option of the plurality of open options.

Example 4 includes the subject matter of any of Examples 1-3, and wherein the dialogue move selection module is to rank each semantic interpretation candidate of the plurality of semantic interpretation candidates further based on a dialogue history.

Example 5 includes the subject matter of any of Examples 1-4, and wherein the dialogue move selection module is further to determine, based on the dialogue history, a plurality of dialogue coherence scores, wherein each dialogue coherence score of the plurality of dialogue coherence scores corresponds to a semantic interpretation candidate of the plurality of semantic interpretation candidates, wherein each dialogue coherence score of the plurality of dialogue coherence scores is indicative of a dialogue coherence of the corresponding semantic interpretation candidate with the dialogue history, and wherein the dialogue move selection module is to rank each semantic interpretation candidate of the plurality of semantic interpretation candidates further based on the plurality of dialogue coherence scores of the plurality of semantic interpretation candidates.

Example 6 includes the subject matter of any of Examples 1-5, and wherein the dialogue move selection module is further to determine, based on the dialogue history, a fulfillment expectation score of each semantic interpretation candidate of the plurality of semantic interpretation candidates, wherein the each fulfillment expectation score is indicative of how well the each corresponding semantic interpretation candidate fulfills an expectation, wherein the expectation is based on the dialogue history, and wherein the dialogue move selection module is to rank each semantic interpretation candidate of the plurality of semantic interpretation candidates further based on the fulfillment expectation scores of the plurality of semantic interpretation candidates.

Example 7 includes the subject matter of any of Examples 1-6, and wherein the dialogue move selection module is to rank each semantic interpretation candidate of the plurality of semantic interpretation candidates further based on an ontology of the compute device.

Example 8 includes the subject matter of any of Examples 1-7, and wherein to rank each semantic interpretation candidate of the plurality of semantic interpretation candidates comprises to rank each semantic interpretation candidate of the plurality of semantic interpretation candidates using a machine-learning-trained algorithm, wherein the dialogue move selection module is further to update, based on the input data, the machine-learning-trained algorithm.

Example 9 includes the subject matter of any of Examples 1-8, and further including a recognized input candidate determination module to determine, based on the input data, a plurality of recognized input candidates, and determine, a plurality of confidence scores, wherein each confidence score corresponds to a recognized input candidate of the plurality of recognized input candidates, and each confidence score indicates a confidence that the corresponding recognized input candidates is a correct input as intended by the user, wherein to determine the plurality of semantic interpretations based on the input data comprises to determine a plurality of semantic interpretations based on the plurality of recognized input candidates and the plurality of confidence scores.

Example 10 includes the subject matter of any of Examples 1-9, and wherein the input data comprises speech data, wherein to determine the plurality of recognized input candidates comprises to perform speech recognition on the input data to determine a plurality of recognized input candidates.

Example 11 includes the subject matter of any of Examples 1-10, and wherein to determine the plurality of semantic interpretation candidates comprises to determine at least two semantic interpretations corresponding to at least two lexical interpretations or to at least two pragmatic interpretations, wherein the at least two lexical interpretations are based on one recognized input candidate of the plurality of recognized input candidates and the at least two pragmatic interpretations are based on one recognized input candidate of the plurality of recognized input candidates.

Example 12 includes the subject matter of any of Examples 1-11, and wherein to determine the plurality of semantic interpretation candidates comprises to determine a plurality of semantic interpretation candidates by parsing each recognized input candidate of the plurality of recognized input candidates.

Example 13 includes the subject matter of any of Examples 1-12, and wherein to determine the plurality of semantic interpretation candidates by parsing each recognized input candidate of the plurality of recognized input candidates comprises to determine at least two semantic interpretations corresponding to at least two syntactic interpretations, wherein the at least two syntactic interpretations are based on one recognized input candidate of the plurality of recognized input candidates.

Example 14 includes the subject matter of any of Examples 1-13, and wherein to determine the plurality of semantic interpretations further comprises to determine a plurality of semantic interpretation candidates based on the plurality of recognized input candidates by applying a machine-learning-based algorithm.

Example 15 includes the subject matter of any of Examples 1-14, and wherein to determine the plurality of semantic interpretations comprises to determine a plurality of semantic interpretation candidates based on the plurality of recognized input candidates by applying a machine-learning-based algorithm.

Example 16 includes the subject matter of any of Examples 1-15, and wherein the input data comprises keyboard data, wherein the recognized input candidate determination module is further to determine an edit distance for each recognized input candidate of the plurality of recognized input candidates, wherein to determine the plurality of confidence scores comprises to determine the plurality of confidence scores based on the edit distances.

Example 17 includes the subject matter of any of Examples 1-16, and wherein the input data comprises gesture data, wherein to determine the plurality of recognized input candidates comprises to perform gesture recognition.

Example 18 includes the subject matter of any of Examples 1-17, and wherein the input data comprises handwriting data, wherein to determine the plurality of recognized input candidates comprises to perform handwriting recognition.

Example 19 includes a method for interpreting an input from a user of a compute device, the method comprising receiving, by the compute device, input data from the user; determining, by the compute device, a plurality of semantic interpretation candidates based on the input data; ranking, by the compute device, each semantic interpretation candidate of the plurality of semantic interpretation candidates; and selecting, by the compute device and based on the ranking, a semantic interpretation of the input data.

Example 20 includes the subject matter of Example 19, and further including providing, by the compute device and to the user, a prompt for an input, wherein receiving input data comprises receiving input data in response to the prompt, and wherein ranking each semantic interpretation candidate of the plurality of semantic interpretation candidates comprises ranking, based on the prompt, each semantic interpretation candidate of the plurality of semantic interpretation candidates.

Example 21 includes the subject matter of any of Examples 19 and 20, and further including determining, by the compute device, a plurality of open options associated with the prompt, wherein ranking each semantic interpretation candidate of the plurality of semantic interpretation candidates further comprises comparing each semantic interpretation candidate of the plurality of semantic interpretation candidates to an open option of the plurality of open options.

Example 22 includes the subject matter of any of Examples 19-21, and wherein ranking each semantic interpretation candidate of the plurality of semantic interpretation candidates is further based on a dialogue history.

Example 23 includes the subject matter of any of Examples 19-22, and further including determining, by the compute device and based on the dialogue history, a plurality of dialogue coherence scores, wherein each dialogue coherence score of the plurality of dialogue coherence scores corresponds to a semantic interpretation candidate of the plurality of semantic interpretation candidates, wherein each dialogue coherence score of the plurality of dialogue coherence scores is indicative of a dialogue coherence of the corresponding semantic interpretation candidate with the dialogue history, and wherein ranking each semantic interpretation candidate of the plurality of semantic interpretation candidates is further based on the dialogue coherence scores of the plurality of semantic interpretation candidates.

Example 24 includes the subject matter of any of Examples 19-23, and further including determining, by the compute device and based on the dialogue history, a fulfillment expectation score of each semantic interpretation candidate of the plurality of semantic interpretation candidates, wherein the each fulfillment expectation score is indicative of how well the each corresponding semantic interpretation candidate fulfills an expectation, wherein the expectation is based on the dialogue history, and wherein ranking each semantic interpretation candidate of the plurality of semantic interpretation candidates is further based on the fulfillment expectation scores of the plurality of semantic interpretation candidates.

Example 25 includes the subject matter of any of Examples 19-24, and wherein ranking each semantic interpretation candidate of the plurality of semantic interpretation candidates is further based on an ontology of the compute device.

Example 26 includes the subject matter of any of Examples 19-25, and wherein ranking each semantic interpretation candidate of the plurality of semantic interpretation candidates comprises ranking each semantic interpretation candidate of the plurality of semantic interpretation candidates using a machine-learning-trained algorithm, the method further comprising updating, by the compute device and based on the input data, the machine-learning-trained algorithm.

Example 27 includes the subject matter of any of Examples 19-26, and further including determining, by the compute device, a plurality of recognized input candidates based on the input data, and determining, by the compute device, a plurality of confidence scores, wherein each confidence score corresponds to a recognized input candidate of the plurality of recognized input candidates, and each confidence score indicates a confidence that the corresponding recognized input candidates is a correct input as intended by the user, wherein determining the plurality of semantic interpretations based on the input data comprises determining a plurality of semantic interpretations based on the plurality of recognized input candidates and the plurality of confidence scores.

Example 28 includes the subject matter of any of Examples 19-27, and wherein the input data comprises speech data, wherein determining the plurality of recognized input candidates comprises performing speech recognition on the input data to determine a plurality of recognized input candidates.

Example 29 includes the subject matter of any of Examples 19-28, and wherein determining the plurality of semantic interpretation candidates comprises determining at least two semantic interpretations corresponding to at least two lexical interpretations or to at least two pragmatic interpretations, wherein the at least two lexical interpretations are based on one recognized input candidate of the plurality of recognized input candidates and the at least two pragmatic interpretations are based on one recognized input candidate of the plurality of recognized input candidates.

Example 30 includes the subject matter of any of Examples 19-29, and wherein determining the plurality of semantic interpretation candidates comprises determining a plurality of semantic interpretation candidates by parsing each recognized input candidate of the plurality of recognized input candidates.

Example 31 includes the subject matter of any of Examples 19-30, and wherein determining the plurality of semantic interpretation candidates by parsing each recognized input candidate of the plurality of recognized input candidates comprises determining at least two semantic interpretations corresponding to at least two syntactic interpretations, wherein the at least two syntactic interpretations are based on one recognized input candidate of the plurality of recognized input candidates.

Example 32 includes the subject matter of any of Examples 19-31, and wherein determining the plurality of semantic interpretations further comprises determining a plurality of semantic interpretation candidates based on the plurality of recognized input candidates by applying a machine-learning-based algorithm.

Example 33 includes the subject matter of any of Examples 19-32, and wherein determining the plurality of semantic interpretations comprises determining a plurality of semantic interpretation candidates based on the plurality of recognized input candidates by applying a machine-learning-based algorithm.

Example 34 includes the subject matter of any of Examples 19-33, and wherein the input data comprises keyboard data, further comprising determining an edit distance for each recognized input candidate of the plurality of recognized input candidates, wherein determining the plurality of confidence scores comprises determining a plurality of confidence scores based on the edit distances.

Example 35 includes the subject matter of any of Examples 19-34, and wherein the input data comprises gesture data, wherein determining the plurality of recognized input candidates comprises performing gesture recognition.

Example 36 includes the subject matter of any of Examples 19-35, and wherein the input data comprises handwriting data, wherein determining the plurality of recognized input candidates comprises performing handwriting recognition.

Example 37 includes one or more machine-readable storage media comprising a plurality of instructions stored thereon that in response to being executed result in a compute device performing the method of any of Examples 19-36.

Example 38 includes a compute device for interpreting an input from a user of the compute device, the compute device comprising means for receiving input data from the user; means for determining a plurality of semantic interpretation candidates based on the input data; means for ranking each semantic interpretation candidate of the plurality of semantic interpretation candidates; and means for selecting, based on the ranking, a semantic interpretation of the input data.

Example 39 includes the subject matter of Example 38, and further including means for providing, to the user, a prompt for an input, wherein the means for receiving input data comprises means for receiving input data in response to the prompt, and wherein the means for ranking each semantic interpretation candidate of the plurality of semantic interpretation candidates comprises means for ranking, based on the prompt, each semantic interpretation candidate of the plurality of semantic interpretation candidates.

Example 40 includes the subject matter of any of Examples 38 and 39, and further including means for determining a plurality of open options associated with the prompt, wherein the means for ranking each semantic interpretation candidate of the plurality of semantic interpretation candidates further comprises means for comparing each semantic interpretation candidate of the plurality of semantic interpretation candidates to an open option of the plurality of open options.

Example 41 includes the subject matter of any of Examples 38-40, and wherein the means for ranking each semantic interpretation candidate of the plurality of semantic interpretation candidates is further based on a dialogue history.

Example 42 includes the subject matter of any of Examples 38-41, and further including means for determining, based on the dialogue history, a plurality of dialogue coherence scores, wherein each dialogue coherence score of the plurality of dialogue coherence scores corresponds to a semantic interpretation candidate of the plurality of semantic interpretation candidates, wherein each dialogue coherence score of the plurality of dialogue coherence scores is indicative of a dialogue coherence of the corresponding semantic interpretation candidate with the dialogue history, and wherein the means for ranking each semantic interpretation candidate of the plurality of semantic interpretation candidates is further based on the dialogue coherence scores of the plurality of semantic interpretation candidates.

Example 43 includes the subject matter of any of Examples 38-42, and further including means for determining, based on the dialogue history, a fulfillment expectation score of each semantic interpretation candidate of the plurality of semantic interpretation candidates, wherein the each fulfillment expectation score is indicative of how well the each corresponding semantic interpretation candidate fulfills an expectation, wherein the expectation is based on the dialogue history, and wherein the means for ranking each semantic interpretation candidate of the plurality of semantic interpretation candidates is further based on the fulfillment expectation scores of the plurality of semantic interpretation candidates.

Example 44 includes the subject matter of any of Examples 38-43, and wherein the means for ranking each semantic interpretation candidate of the plurality of semantic interpretation candidates is further based on an ontology of the compute device.

Example 45 includes the subject matter of any of Examples 38-44, and wherein the means for ranking each semantic interpretation candidate of the plurality of semantic interpretation candidates comprises ranking each semantic interpretation candidate of the plurality of semantic interpretation candidates using a machine-learning-trained algorithm, the compute device further comprising means for updating, based on the input data, the machine-learning-trained algorithm.

Example 46 includes the subject matter of any of Examples 38-45, and further including means for determining a plurality of recognized input candidates based on the input data, and means for determining a plurality of confidence scores, wherein each confidence score corresponds to a recognized input candidate of the plurality of recognized input candidates, and each confidence score indicates a confidence that the corresponding recognized input candidates is a correct input as intended by the user, wherein the means for determining the plurality of semantic interpretations based on the input data comprises means for determining a plurality of semantic interpretations based on the plurality of recognized input candidates and the plurality of confidence scores.

Example 47 includes the subject matter of any of Examples 38-46, and wherein the input data comprises speech data, wherein the means for determining the plurality of recognized input candidates comprises means for performing speech recognition on the input data to determine a plurality of recognized input candidates.

Example 48 includes the subject matter of any of Examples 38-47, and wherein the means for determining the plurality of semantic interpretation candidates comprises means for determining at least two semantic interpretations corresponding to at least two lexical interpretations or to at least two pragmatic interpretations, wherein the at least two lexical interpretations are based on one recognized input candidate of the plurality of recognized input candidates and the at least two pragmatic interpretations are based on one recognized input candidate of the plurality of recognized input candidates.

Example 49 includes the subject matter of any of Examples 38-48, and wherein the means for determining the plurality of semantic interpretation candidates comprises means for determining a plurality of semantic interpretation candidates by parsing each recognized input candidate of the plurality of recognized input candidates.

Example 50 includes the subject matter of any of Examples 38-49, and wherein the means for determining the plurality of semantic interpretation candidates by parsing each recognized input candidate of the plurality of recognized input candidates comprises means for determining at least two semantic interpretations corresponding to at least two syntactic interpretations, wherein the at least two syntactic interpretations are based on one recognized input candidate of the plurality of recognized input candidates.

Example 51 includes the subject matter of any of Examples 38-50, and wherein the means for determining the plurality of semantic interpretations further comprises means for determining a plurality of semantic interpretation candidates based on the plurality of recognized input candidates by applying a machine-learning-based algorithm.

Example 52 includes the subject matter of any of Examples 38-51, and wherein the means for determining the plurality of semantic interpretations comprises means for determining a plurality of semantic interpretation candidates based on the plurality of recognized input candidates by applying a machine-learning-based algorithm.

Example 53 includes the subject matter of any of Examples 38-52, and wherein the input data comprises keyboard data, further comprising means for determining an edit distance for each recognized input candidate of the plurality of recognized input candidates, wherein the means for determining the plurality of confidence scores comprises means for determining a plurality of confidence scores based on the edit distances.

Example 54 includes the subject matter of any of Examples 38-53, and wherein the input data comprises gesture data, wherein the means for determining the plurality of recognized input candidates comprises means for performing gesture recognition.

Example 55 includes the subject matter of any of Examples 38-54, and wherein the input data comprises handwriting data, wherein the means for determining the plurality of recognized input candidates comprises means for performing handwriting recognition.

1. A compute device for interpreting an input from a user of the compute device comprising:
an input data capture module to receive input data from the user;
a semantic interpretation candidate determination module to determine a plurality of semantic interpretation candidates based on the input data; and
a dialogue move selection module to (i) rank each semantic interpretation candidate of the plurality of semantic interpretation candidates and (ii) select, based on the ranking, a semantic interpretation of the input data.

2. The compute device of claim 1, further comprising a dialogue manager module to provide, to the user, a prompt for input, wherein to receive input data comprises to receive input data in response to the prompt, and wherein to rank each semantic interpretation candidate of the plurality of semantic interpretation candidates comprises to rank, based on the prompt, each semantic interpretation candidate of the plurality of semantic interpretation candidates.

3. The compute device of claim 1, wherein the dialogue move selection module is further to:
determine, based on the dialogue history, a plurality of dialogue coherence scores, wherein each dialogue coherence score of the plurality of dialogue coherence scores corresponds to a semantic interpretation candidate of the plurality of semantic interpretation candidates,
wherein each dialogue coherence score of the plurality of dialogue coherence scores is indicative of a dialogue coherence of the corresponding semantic interpretation candidate with the dialogue history, and
wherein the dialogue move selection module is to rank each semantic interpretation candidate of the plurality of semantic interpretation candidates further based on a dialogue history and the plurality of dialogue coherence scores of the plurality of semantic interpretation candidates.

4. The compute device of claim 1, further comprising:
a recognized input candidate determination module to:
determine, based on the input data, a plurality of recognized input candidates, and
determine, a plurality of confidence scores, wherein each confidence score corresponds to a recognized input candidate of the plurality of recognized input candidates, and each confidence score indicates a confidence that the corresponding recognized input candidates is a correct input as intended by the user,
wherein to determine the plurality of semantic interpretations based on the input data comprises to determine a plurality of semantic interpretations based on the plurality of recognized input candidates and the plurality of confidence scores.

5. The compute device of claim 4, wherein the input data comprises speech data, wherein to determine the plurality of recognized input candidates comprises to perform speech recognition on the input data to determine a plurality of recognized input candidates.

6. The compute device of claim 5, wherein to determine the plurality of semantic interpretation candidates comprises to determine a plurality of semantic interpretation candidates by parsing each recognized input candidate of the plurality of recognized input candidates.

7. The compute device of claim 6, wherein to determine the plurality of semantic interpretation candidates by parsing each recognized input candidate of the plurality of recognized input candidates comprises to determine at least two semantic interpretations corresponding to at least two syntactic interpretations, wherein the at least two syntactic interpretations are based on one recognized input candidate of the plurality of recognized input candidates.

8. The compute device of claim 6, wherein to determine the plurality of semantic interpretations further comprises to determine a plurality of semantic interpretation candidates based on the plurality of recognized input candidates by applying a machine-learning-based algorithm.

9. The compute device of claim 4, wherein the input data comprises keyboard data, wherein the recognized input candidate determination module is further to determine an edit distance for each recognized input candidate of the plurality of recognized input candidates, wherein to determine the plurality of confidence scores comprises to determine the plurality of confidence scores based on the edit distances.

10. The compute device of claim 4, wherein the input data comprises handwriting data, wherein to determine the plurality of recognized input candidates comprises to perform handwriting recognition.

11. One or more computer-readable media comprising a plurality of instructions stored thereon that, when executed, cause a compute device to:
receive input data from the user;
determine a plurality of semantic interpretation candidates based on the input data;
rank each semantic interpretation candidate of the plurality of semantic interpretation candidates; and
select, based on the ranking, a semantic interpretation of the input data.

12. The one or more computer-readable media of claim 11, wherein the plurality of instructions further cause the compute device to provide, to the user, a prompt for an input, wherein to receive input data comprises to receive input data in response to the prompt, and wherein to rank each semantic interpretation candidate of the plurality of semantic interpretation candidates comprises to rank, based on the prompt, each semantic interpretation candidate of the plurality of semantic interpretation candidates.

13. The one or more computer-readable media of claim 11, wherein the plurality of instructions further cause the compute device to:
determine, based on the dialogue history, a plurality of dialogue coherence scores, wherein each dialogue coherence score of the plurality of dialogue coherence scores corresponds to a semantic interpretation candidate of the plurality of semantic interpretation candidates,
wherein each dialogue coherence score of the plurality of dialogue coherence scores is indicative of a dialogue coherence of the corresponding semantic interpretation candidate with the dialogue history, and
wherein to rank each semantic interpretation candidate of the plurality of semantic interpretation candidates is further based on a dialogue history and the dialogue coherence scores of the plurality of semantic interpretation candidates.

14. The one or more computer-readable media of claim 11, wherein the plurality of instructions further cause the compute device to:
determine a plurality of recognized input candidates based on the input data, and
determine a plurality of confidence scores, wherein each confidence score corresponds to a recognized input candidate of the plurality of recognized input candidates, and each confidence score indicates a confidence that the corresponding recognized input candidates is a correct input as intended by the user,
wherein to determine the plurality of semantic interpretations based on the input data comprises to determine a plurality of semantic interpretations based on the plurality of recognized input candidates and the plurality of confidence scores.

15. The one or more computer-readable media of claim 14, wherein the input data comprises speech data, wherein to determine the plurality of recognized input candidates comprises to perform speech recognition on the input data to determine a plurality of recognized input candidates.

16. The one or more computer-readable media of claim 15, wherein to determine the plurality of semantic interpretation candidates comprises to determine a plurality of semantic interpretation candidates by parsing each recognized input candidate of the plurality of recognized input candidates.

17. The one or more computer-readable media of claim 16, wherein to determine the plurality of semantic interpretation candidates by parsing each recognized input candidate of the plurality of recognized input candidates comprises to determine at least two semantic interpretations corresponding to at least two syntactic interpretations, wherein the at least two syntactic interpretations are based on one recognized input candidate of the plurality of recognized input candidates.

18. The one or more computer-readable media of claim 14, wherein the input data comprises keyboard data, wherein the plurality of instructions further cause the compute device to determine an edit distance for each recognized input candidate of the plurality of recognized input candidates, wherein to determine the plurality of confidence scores comprises to determine a plurality of confidence scores based on the edit distances.

19. A method for interpreting an input from a user of a compute device, the method comprising:
receiving, by the compute device, input data from the user;
determining, by the compute device, a plurality of semantic interpretation candidates based on the input data;
ranking, by the compute device, each semantic interpretation candidate of the plurality of semantic interpretation candidates; and
selecting, by the compute device and based on the ranking, a semantic interpretation of the input data.

20. The method of claim 19, further comprising providing, by the compute device and to the user, a prompt for an input, wherein receiving input data comprises receiving input data in response to the prompt, and wherein ranking each semantic interpretation candidate of the plurality of semantic interpretation candidates comprises ranking, based on the prompt, each semantic interpretation candidate of the plurality of semantic interpretation candidates.

21. The method of claim 19, further comprising:
determining, by the compute device and based on the dialogue history, a plurality of dialogue coherence scores, wherein each dialogue coherence score of the plurality of dialogue coherence scores corresponds to a semantic interpretation candidate of the plurality of semantic interpretation candidates,
wherein each dialogue coherence score of the plurality of dialogue coherence scores is indicative of a dialogue coherence of the corresponding semantic interpretation candidate with the dialogue history, and
wherein ranking each semantic interpretation candidate of the plurality of semantic interpretation candidates is further based on a dialogue history and the dialogue coherence scores of the plurality of semantic interpretation candidates.

22. The method of claim 19, further comprising:
determining, by the compute device, a plurality of recognized input candidates based on the input data, and
determining, by the compute device, a plurality of confidence scores, wherein each confidence score corresponds to a recognized input candidate of the plurality of recognized input candidates, and each confidence score indicates a confidence that the corresponding recognized input candidates is a correct input as intended by the user,
wherein determining the plurality of semantic interpretations based on the input data comprises determining a plurality of semantic interpretations based on the plurality of recognized input candidates and the plurality of confidence scores.

23. The method of claim 22, wherein the input data comprises speech data, wherein determining the plurality of recognized input candidates comprises performing speech recognition on the input data to determine a plurality of recognized input candidates.

24. The method of claim 23, wherein determining the plurality of semantic interpretation candidates comprises determining a plurality of semantic interpretation candidates by parsing each recognized input candidate of the plurality of recognized input candidates.

25. The method of claim 22, wherein the input data comprises keyboard data, further comprising determining an edit distance for each recognized input candidate of the plurality of recognized input candidates, wherein determining the plurality of confidence scores comprises determining a plurality of confidence scores based on the edit distances.
